(19) United States
(12) Patent Application Publication
(10) Pub. No.: US 2012/0115358 A1
(43) Pub. Date: May 10, 2012

(54) TERMINAL STRUCTURE FOR COAXIAL CONNECTOR

(75) Inventor: Ching-Yang Chiu, Taipei (TW)

(73) Assignee: PRIMECON TECHNOLOGY LTD., Taipei (TW)

(21) Appl. No.: 12/940,372

(22) Filed: Nov. 5, 2010

(51) Int. Cl. H01R 9/05

(52) U.S. Cl. 439/578

(57) ABSTRACT

A terminal structure for coaxial connector includes a terminal main body having a carrier plate and two contacts near a first end of the carrier plate; a first fastening tab located on one lateral side of the carrier plate adjacent to an opposite second end thereof; and a second fastening tab located at the other lateral side of the carrier plate at the second end thereof to be diagonally symmetrical to the first fastening tab. By bending the first and second fastening tabs inward to abut on each other end to end, a core of a cable can be clamped between the two fastening tabs and thereby easily and firmly assembled to the carrier plate to ensure good electric contact between the core and the terminal main body.

### FIELD OF THE INVENTION

The present invention relates to a terminal structure for coaxial connector, and more particularly to a coaxial connector terminal structure that not only ensures easy and firm assembly of a core of a cable to the terminal structure and accordingly, but also ensures good electric contact between the cable and the coaxial connector.

### BACKGROUND OF THE INVENTION

Generally, a convention coaxial connector includes a signal terminal, an insulating body, and an electrically conducting body. The signal terminal has a welding area and two plate-shaped contacts downward and inward extended from two ends of the welding area to face each other. The signal terminal is provided at a rear end with a pair of vertical posts, such that a recess is formed between the two posts for a core of a coaxial cable to dispose thereon. To assemble the core to the coaxial connector, first weld the core to the welding area on the signal terminal. The signal terminal with the core welded thereto is then disposed in the insulating body, and a pressing cover is downward bent with a tool so as to press against the signal terminal and complete a coaxial connector.

Since the core must be welded to the welding area on the signal terminal, and a tool must be used to downward bend and press the pressing cover against the signal terminal, the procedures for assembling the cable core to the coaxial connector are complicated and a lot of time and labor is consumed. Further, solder spatters and other impurities tend to occur in the process of welding, which would have adverse influence on the electric characteristics of the products. Moreover, when the pressing cover is bent, it is very often the pressing cover is deviated to decrease the good yield and the quality of the products.

It is therefore tried by the inventor to develop an improved terminal structure for coaxial connector, which allows easy assembling of a cable core thereto while ensures good electric contact between the cable and the coaxial connector, so as to overcome the drawbacks in the prior art coaxial connector terminals.

### SUMMARY OF THE INVENTION

A primary object of the present invention is to provide a terminal structure for coaxial connector that is provided with a first and a second fastening tab for firmly clamping a core of a cable to a terminal main body, so as to provide good electric contact between the cable and the coaxial connector.

To achieve the above and other objects, the terminal structure for coaxial connector according to the present invention includes a terminal main body having a carrier plate and two contacts correspondingly located at two lateral sides of the carrier plate near a first end thereof; a first fastening tab being located at one lateral side of the carrier plate adjacent to an opposite second end of the carrier plate; and a second fastening tab being located at the other lateral side of the carrier plate adjacent to the second end of the carrier plate to correspond to the first fastening tab.

According to an embodiment of the present invention, the terminal main body, the first fastening tab, and the second fastening tab are integrally formed of a metal material, and the carrier plate of the terminal main body is connected at the first end to a material strip.

According to an embodiment of the present invention, the first and the second fastening tab are two diagonally symmetric tabs respectively having a dent formed at one lateral side thereof, allowing the first and second fastening tabs to fitly abut on each other end to end.

According to an embodiment of the present invention, the first and the second fastening tab are bent toward each other to thereby clamp a core of a cable therebetween, bringing the core to firmly assemble to the second end of the carrier plate of the terminal main body; and the terminal main body with the core assembled thereto is then mounted in a plastic base before the plastic base is further mounted in an enclosure of the coaxial connector. The plastic base defines a receiving space slightly smaller than a volume of the terminal main body for tightly receiving the terminal main body therein, and includes an extended section located at an end closer to the first end of the carrier plate. The enclosure includes a bendable cover portion corresponding to the extended section of the plastic base.

With the above arrangements, a core of a cable can be easily and firmly assembled to the terminal structure of the present invention simply by bending the first and the second fastening tab inward for them to abut on each other end to end, and a good electric contact between the cable and the coaxial connector can be ensured.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a terminal structure for coaxial connector according to a preferred embodiment of the present invention;

FIG. 2 is an exploded perspective view showing the assembling of a core of a cable to the coaxial connector terminal structure of the present invention;

FIG. 3 is an assembled view of FIG. 2;

FIG. 4 is an exploded view showing the coaxial connector terminal structure with the cable core assembled thereto as shown in FIG. 3 is further assembled to a plastic base;

FIG. 5 is an assembled view of FIG. 4;

FIG. 6 is an exploded view showing the sub-assembly of FIG. 5 is further assembled to an enclosure of the coaxial connector;

FIG. 7 is an assembled view of FIG. 6; and

FIG. 8 is a partially sectional view showing the enclosure is bent to complete a coaxial connector with the terminal structure of the present invention.

### DETAILED DESCRIPTION OF THE PREFERRED EMBODIMENTS

The present invention will now be described in more details with a preferred embodiment thereof and with reference to the accompanying drawings.

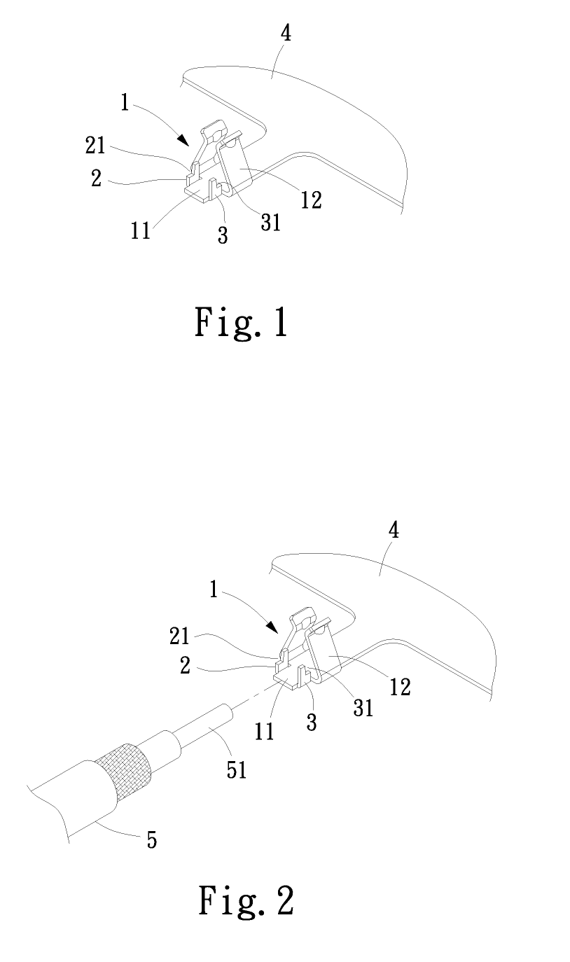

Please refer to FIG. 1 that is a perspective view of a terminal structure for coaxial connector according to a preferred embodiment of the present invention. As shown, the terminal structure for coaxial connector includes a terminal main body 1, a first fastening tab 2, and a second fastening tab 3. The terminal main body 1, the first fastening tab 2, and the second fastening tab 3 are integrally formed of a metal material.

The terminal main body 1 includes a carrier plate 11, and two contacts 12 separately located at two lateral sides of the carrier plate 11 near a first end thereof and correspondingly bent toward one face of the carrier plate 11.

The first fastening tab 2 is located at one lateral side of the carrier plate 11 adjacent to an opposite second end of the carrier plate 11; and the first end of the carrier plate 11 is connected to a material strip 4.

The second fastening tab 3 is located at the other lateral side of the carrier plate 11 adjacent to the second end of the carrier plate 11 to correspond to the first fastening tab 2. The first and the second fastening tab 2, 3 are two diagonally symmetric tabs respectively having a dent 21, 31 formed at one lateral side thereof, such that the first and second fastening tabs 2, 3 can be bent to fitly abut on each other end to end.

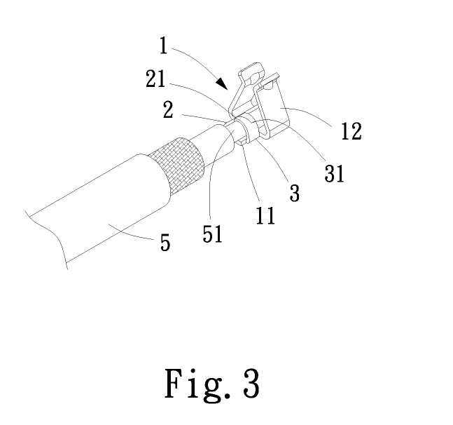

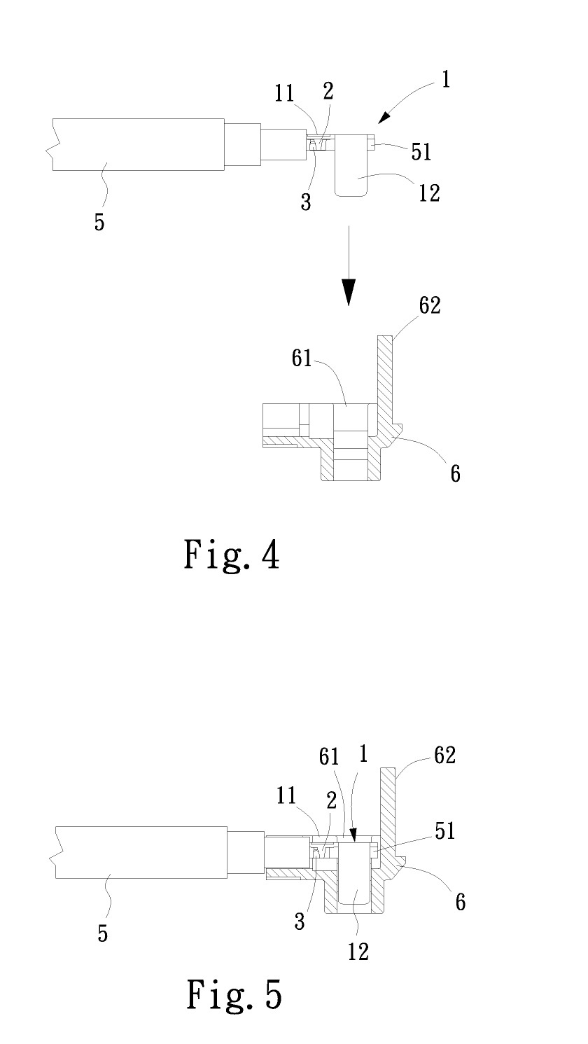

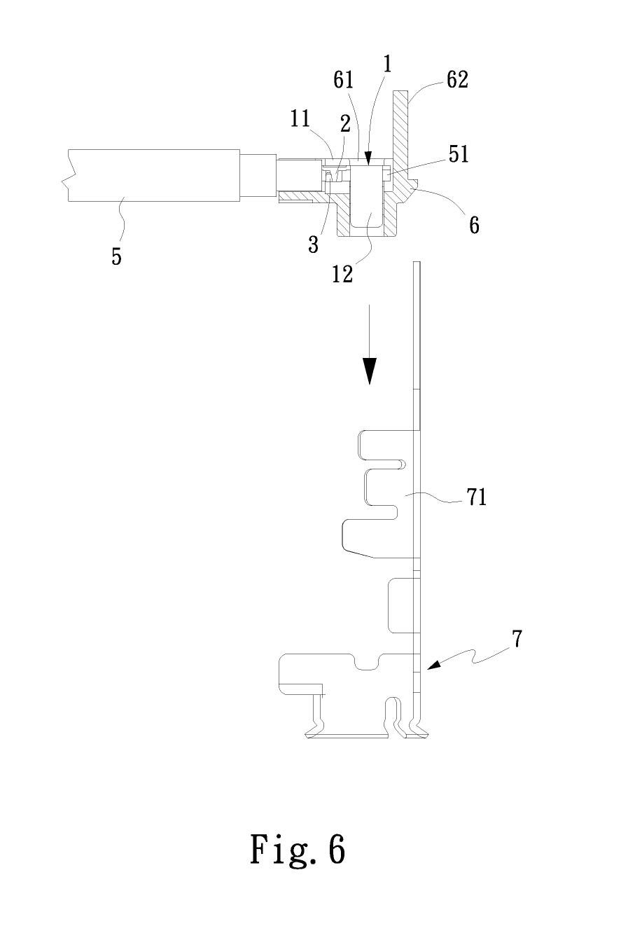

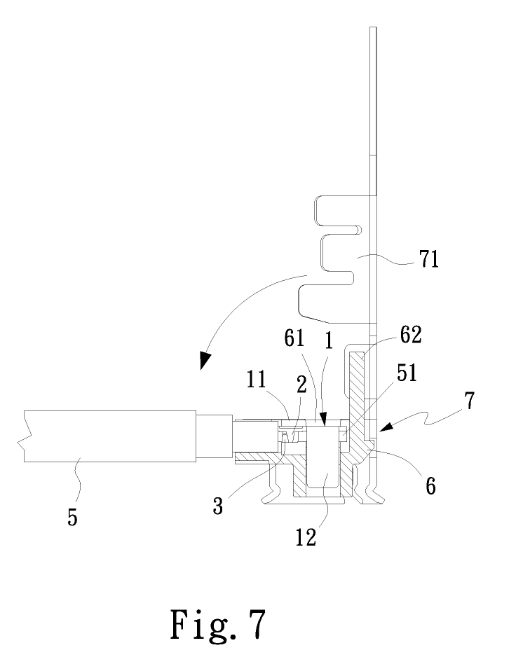

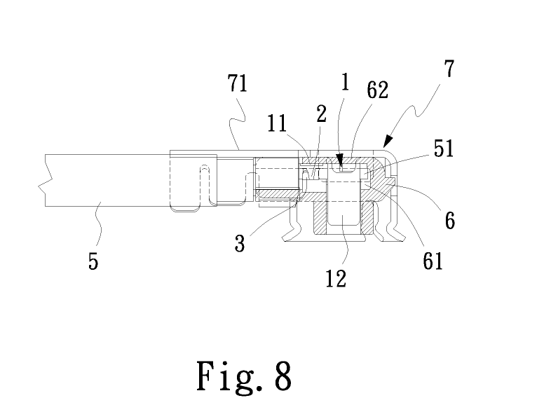

FIGS. 2 and 3 respectively show the coaxial connector terminal structure of the present invention before and after a core of a cable is assembled thereto; FIGS. 4 and 5 respectively show the subassembly of FIG. 3 before and after being further mounted in a plastic base; FIGS. 6 and 7 respectively show the subassembly of FIG. 5 before and after being further mounted in an enclosure for a coaxial connector; and FIG. 8 shows the enclosure is bent to complete a coaxial connector.

Please refer to FIGS. 2 to 8. To assemble a core 51 of a cable 5 to the terminal structure of coaxial connector according to the present invention, first dispose the core 51 of the cable 5 on the carrier plate 11 at the second end thereof to locate between the first and the second fastening tab 2, 3; and use a tool or a fixture (not shown) to simultaneously or separately bend the first and the second fastening tab 2, 3 toward the core 51, such that the dent 21 of the first fastening tab 2 fitly engages with the second fastening tab 3 while the dent 31 of the second fastening tab 3 fitly engages with the first fastening tab 2, bringing the first and the second fastening tab 2, 3 to abut on each other end to end and therefore firmly hold the core 51 to the terminal main body 1. With the above arrangements, the terminal main body 1 and the core 51 can be easily assembled together to provide good electrical contact between them.

Then, cut the first end of the carrier plate 11 to separate the terminal main body 1 of the terminal structure from the material strip 4, and mount a subassembly of the terminal main body 1 and the core 51 in a plastic base 6. The plastic base 6 defines a receiving space 61 for receiving the terminal main body 1 therein, and includes an extended section 62 located at an end of the plastic base 6 closer to the first end of the carrier plate 11. The receiving space 61 is slightly smaller than a volume of the terminal main body 1. Due to an elasticity of the plastic base 6, the receiving space 61 can be slightly expanded to allow setting of the terminal main body 1 in the receiving space 61 before the latter is elastically restored to tightly fit around the terminal main body 1. Thereafter, dispose the plastic base 6 along with the terminal main body 1 and the cable 5 in an enclosure 7 of the coaxial connector. Finally, bend a cover portion 71 of the enclosure 7 toward the plastic base 6 to clamp on an outer sheath of the cable 5. At this point, the bent cover portion 71 of the enclosure 7 would also force the extended section 62 of the plastic base 6 downward to press against the terminal main body 1, so that the extended section 62 of the plastic base 6 not only forms an insulating structure between the terminal main body 1 and the enclosure 7, but also exerts pressure on the terminal main body 1 for the latter to more firmly associate with the whole plastic base 6 and complete the coaxial connector for connecting to a desired electronic apparatus. An end of the cable 5 opposite to the coaxial connector can be connected to, for example, an antenna module (not shown). The contacts 12 on the terminal main body 1 can cooperate with the cable 5 to enable transmission of electric signals. Since the terminal main body 1 and the core 51 can be firmly connected to each other via the first and the second fastening tab 2 and 3, the completed coaxial connector in use can ensure good electric characteristics thereof.

In the present invention, the first and the second fastening tab are designed to be diagonally symmetrical to each other and can therefore be fully fitly abutted on each other end to end, bringing the core of the cable to be easily and firmly assembled to the terminal main body to ensure good electric contact and signal transmission. It is expected products derived from the present invention would no doubt satisfy the current market demands. Therefore, with the above arrangements, the terminal structure for coaxial connector according to the present invention is novel, improved and industrially useful.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A terminal structure for coaxial connector, comprising:
a terminal main body including a carrier plate, and two contacts separately located at two lateral sides of the carrier plate near a first end thereof and correspondingly bent toward one face of the carrier plate;
a first fastening tab being located at one lateral side of the carrier plate adjacent to an opposite second end of the carrier plate; and
a second fastening tab being located at the other lateral side of the carrier plate adjacent to the second end of the carrier plate to correspond to the first fastening tab.

2. The terminal structure for coaxial connector as claimed in claim 1, wherein the terminal main body, the first fastening tab and the second fastening tab are integrally formed of a metal material, and the first end of the carrier plate is connected to a material strip.

3. The terminal structure for coaxial connector as claimed in claim 1, wherein the first and the second fastening tab are two diagonally symmetric tabs respectively having a dent formed at one lateral side thereof, allowing the first and second fastening tabs to fitly abut on each other end to end.

4. The terminal structure for coaxial connector as claimed in claim 1, wherein the first and the second fastening tab are bent toward each other to thereby clamp a core of a cable therebetween, bringing the core to firmly assemble to the second end of the carrier plate of the terminal main body; and wherein the terminal main body with the core assembled thereto is then mounted in a plastic base before the plastic base is further mounted in an enclosure of the coaxial connector; the plastic base defining a receiving space slightly smaller than a volume of the terminal main body for tightly receiving the terminal main body therein, and including an extended section located at an end closer to the first end of the carrier plate; and the enclosure including a bendable cover portion corresponding to the extended section of the plastic base.
